(19) United States
(12) Patent Application Publication
(10) Pub. No.: US 2016/0135260 A1
(43) Pub. Date: May 12, 2016

(54) SWITCHING CIRCUIT FOR LIGHT-EMITTING DIODE

(71) Applicant: Wisetop Technology Co., Ltd., Hsinchu City (TW)

(72) Inventors: Pin CHANG, Hsinchu City (TW); Wei-Chen LIANG, Baoshan Township (TW)

(21) Appl. No.: 14/939,806

(22) Filed: Nov. 12, 2015

(30) Foreign Application Priority Data
Nov. 12, 2014 (TW) 103139273

(51) Int. Cl. H05B 33/08

(52) U.S. Cl. CPC H05B 33/0815

(57) ABSTRACT

A switch circuit for light-emitting diode is provided. The switch circuit includes a power module, a light-emitting diode module, an inductor, a first switch, a second switch and a capacitor. When the input voltage of the power module is higher than the forward bias voltage of the light-emitting diode module, the first switch is switched repeatedly and the second switch is turned off, so that the power supply can charge the inductor and/or the capacitor. When the input voltage of the power module and the storage voltage of the capacitor both are lower than the forward bias voltage of the light-emitting diode module, the first switch and the second switch are controlled to switch repeatedly and synchronously, so that the power energy of the power module or the discharge energy of the capacitor can be used to continuously charge the inductor.

### CROSS-REFERENCE TO RELATED APPLICATION

This application claims the benefit of Taiwan Patent Application No. 103139273, filed on Nov. 12, 2014, in the Taiwan Intellectual Property Office, the disclosure of which is incorporated herein in its entirety by reference.

### BACKGROUND

1. Technical Field

The present invention relates to a switch circuit for light-emitting diode, more particularly, to a switch circuit for controlling power supply to the light-emitting diode.

2. Description of Related Art

Please refer to FIG. 1 which shows a circuit view of a conventional switch circuit for light-emitting diode. As shown in FIG. 1, the conventional switch circuit for light-emitting diode 100 can be a boost converter including a power module 10, a switch 11, an inductor 12, a light-emitting diode 13 and a capacitor 15.

The power module 10 is a bridge rectifier including a first terminal (such as positive terminal) and a second terminal (such as a negative terminal) and configured to convert commercial AC power V_{AC} into a DC input voltage V_{IN} with pulses. An end of the inductor 12 is electrically connected to the first terminal of the power module 10. The switch 11 has an end (such as a drain terminal or a collector terminal) electrically connected to other end of the inductor 12, and a control terminal (such as a gate terminal or a base terminal) receiving a control signal S, and a second end (such as a source terminal or an emitter terminal) electrically connected to the second terminal of the power module 10 via a load element. The light-emitting diode 13 has a first terminal (such as an anode) electrically connected to the other end of the inductor 12 via a diode 121, and a second terminal (such as a cathode) electrically connected to the second terminal of the power module 10 via the load element. The capacitor 15 and the light-emitting diode 13 are electrically connected in parallel.

When the switch 11 is controlled to turn off, the light-emitting diode 13 is driven to emit light by current discharged from the inductor 12, and the capacitor 15 is charged simultaneously. When the switch 11 is controlled to turn on, the light-emitting diode 13 is driven to emit light by current discharged from the capacitor 15, and the inductor 12 is charged based on the input voltage V_{IN}.

In design of using conventional boost switch circuit 100, the forward bias voltage V_{F} of the light-emitting diode 13 must be greater than the maximum voltage value (Vₘₐₓ) of the input voltage V_{IN}, otherwise the switch circuit 100 sometimes fails to work. In conventional circuit design, a higher forward bias voltage V_{F} is implemented by serially connecting multiple light-emitting diodes, but such design causes a higher cost and the higher forward bias voltage V_{F} also cause a problem of not easily driving the light-emitting diode 13 to emit light.

Alternatively, a conventional buck converter is also used as switch circuit for controlling operation of the light-emitting diode; however, such switch circuit is only effectively worked while the pulse of the input voltage V_{IN} must be higher than the forward bias voltage V_{F} of the light-emitting diode, which results in severe limitation in operation time of the light-emitting diode. Therefore, the conventional boost switch circuit or buck switch circuit has limitation in usage.

### SUMMARY

An objective of the present invention is to provide a switch circuit for light-emitting diode, and the switch circuit is designed to use the energy from the power module as much as possible to drive the light-emitting diode module to emit light or charge the inductor, so as to delay the discharging time of the capacitor. Therefore, a capacitor with a lower capacitance can be selected to use in the switch circuit to reduce volume and cost of the switch circuit, and a power factor of the circuitry system can be effectively improved and the high-frequency glitter of the light-emitting diode module can be effectively solved.

An objective of the present invention is to provide a switch circuit for light-emitting diode, and the switch circuit is provided with a capacitor charge-discharge control module configured to stop charging or discharging of the capacitor, so that the capacitor with lower capacitance can be selected to use in the switch circuit. Therefore, the high-frequency glitter of the light-emitting diode module can be effectively solved.

An objective of the present invention is to provide a switch circuit for light-emitting diode and the switch circuit has a two-part capacitor unit. When the total storage voltage of the two-part capacitor unit is charged to the power supply voltage of the power module and the two-part capacitor unit fails to be charged by the power module, a switch corresponding to a capacitor of the two-part capacitor unit is controlled to turn on to generate other current path, so that the power module can continue charging the capacitor via the other current path to increase the storage voltage of the capacitor to reach the level of the power supply voltage of the power module. Therefore, the charging time of the two-part capacitor unit can be extended and a power factor of the circuit system can be improved, and the charge quantity of the two-part capacitor unit can be increased to raise the storage voltage.

To achieve aforesaid objectives, the present invention provides a switch circuit for light-emitting diode, and the switch circuit includes a power module, a light-emitting diode module, an inductor, a first switch, a second switch and a first capacitor. The power module has a first terminal and a second terminal. The light-emitting diode module has a first terminal and a second terminal, and the first terminal of the light-emitting diode module is connected to the first terminal of the power module. The inductor has an end connected to the second terminal of the light-emitting diode module. The first switch has a first end connected to other end of the inductor, a control end configured to receive a first control signal, and a second end connected to the second terminal of the power module. The first switch is controlled to turn on or off according to the first control signal. The second switch has a first end connected to the first terminal of the light-emitting diode module, a control end configured to receive a second control signal control signal and a second end connected to the second terminal of the light-emitting diode module. The second switch is controlled to turn on or off according to the second control signal. The first capacitor has an end connected to the other end of the inductor via a first diode and connected to the first terminal of the light-emitting diode module and the first end of the second switch via a second diode, and has other end connected to the second terminal of the power module.

In an embodiment of the present invention, the second end of the first switch is connected to the second terminal of the power module via a first resistor and a second resistor which are serially connected, the other end of the first capacitor is connected to the second terminal of the power module via the second resistor, and the resistance ratio of the first resistor and the second resistor is set to determine a ratio of current provided by the power module and discharge current of the first capacitor.

In an embodiment of the present invention, the light-emitting diode module comprises a light-emitting diode element and a capacitor element, and the light-emitting diode element and the capacitor element are connected in parallel.

In an embodiment of the present invention, the switch circuit further includes a second capacitor disposed between the second terminal of the light-emitting diode module and the second terminal of the power module.

In an embodiment of the present invention, the switch circuit further includes a third switch having a first end connected to the end of the first capacitor, a control end configured to receive a third control signal, and a second end connected to the first terminal of the light-emitting diode module and the first end of the second switch via the second diode. The third switch is controlled to turn on, turn off or limit current according to the third control signal.

In an embodiment of the present invention, the switch circuit further includes a third switch having a first end connected to the end of the first capacitor via the second diode, a control end configured to receive a third control signal, and a second end connected to the first terminal of the light-emitting diode module and the first end of the second switch. The third switch is controlled to turn on, turn off, or limit current according to the third control signal.

In an embodiment of the present invention, the first end of the second switch is connected to the first terminal of the light-emitting diode module via the third diode.

In an embodiment of the present invention, the second switch is controlled to turn on, so as to enable the power module to directly charge the inductor without via the light-emitting diode module.

To achieve aforesaid objectives, the present invention further provides a switch circuit for light-emitting diode, and the switch circuit includes a power module, a light-emitting diode module, an inductor, a first switch, a first capacitor and a second capacitor. The power module has a first terminal and a second terminal. The light-emitting diode module has a first terminal and a second terminal, and the first terminal of the light-emitting diode module connected to the first terminal of the power module. The inductor has an end connected to the second terminal of the light-emitting diode module. The first switch has a first end connected to other end of the inductor, a control end configured to receive a first control signal, and a second end connected to the second terminal of the power module. The first switch is controlled to turn on or turn off according to the first control signal. The first capacitor has an end connected to other end of the inductor via a first diode and connected to the first terminal of the light-emitting diode module via a second diode, and other end connected to the second terminal of the power module. The second capacitor is disposed between the second terminal of the light-emitting diode module and the second terminal of the power module.

To achieve aforesaid objectives, the present invention further provides a switch circuit for light-emitting diode, and the switch circuit includes a power module, a light-emitting diode module, an inductor, a first switch and a first capacitor. The power module has a first terminal and a second terminal. The light-emitting diode module has a first terminal and a second terminal. The inductor has an end connected to the first terminal of the power module and connected to the second terminal of the light-emitting diode module via a first diode, and having other end connected to the first terminal of the light-emitting diode module. The first switch has a first end connected to the other end of the inductor, a control end configured to receive a first control signal, and a second end connected to the second terminal of the power module. The first switch is controlled to turn on or turn off according to the first control signal. The first capacitor has an end connected to the second terminal of the light-emitting diode module, and other end connected to the second terminal of the power module.

In an embodiment of the present invention, the switch circuit further includes a capacitor charge-discharge control module disposed between the other end of the first capacitor and the second terminal of the power module. The capacitor charge-discharge control module includes a first switch element, a second switch element and a control element. A first end of the first switch element is connected to the other end of the first capacitor, a first end of the second switch element is connected to the second terminal of the power module, a second end of the first switch element and a second end of the second switch element both are connected to the control element, control ends of the first switch element and the second switch element are respectively connected to the control element. The first capacitor is stopped being discharged when the second switch element is controlled by the control element to turn off. The first capacitor is stopped being charged when the first switch element is controlled by the control element to turn off.

In an embodiment of the present invention, the switch circuit further includes a second switch and a second capacitor. The second capacitor has an end connected to the other end of the first capacitor via a second diode and connected to the end of the inductor via a third diode, and has other end connected to the second terminal of the power module. A fourth diode is connected between the other end of the first capacitor and the other end of the second capacitor in parallel. The second switch has a first end connected to the other end of the first capacitor, a control end configured to receive a second control signal, and a second end connected to the second terminal of the power module. The power module charges the first capacitor and the second capacitor when the first switch and the second switch are controlled to turn off, and the power module charges the first capacitor when the first switch is controlled to turn off and the second switch is controlled to turn on.

In an embodiment of the present invention, the switch circuit further includes a third switch and a second capacitor. The second capacitor has an end connected to the other end of the first capacitor via a second diode and connected to the end of the inductor via a third diode, and has other end connected to the second terminal of the power module. A fourth diode is connected between the other end of the first capacitor and the other end of the second capacitor in parallel. The third switch has a first end connected to the end of the first capacitor, a control end configured to receive a third control signal, and a second end connected to an end of the second capacitor via a fifth diode. The power module charges the first capacitor and the second capacitor when the first switch and the third switch are controlled to turn off, and the power module charges the second capacitor when the first switch is controlled to turn off and the third switch is controlled to turn on.

In an embodiment of the present invention, the switch circuit further includes a fourth switch having a first end connected to the end of the first capacitor, a control end configured to receive a fourth control signal, and a second end connected to the end of the inductor via the first diode. The fourth switch is controlled to turn on, turn off, or limit current according to the control signal.

In an embodiment of the present invention, the light-emitting diode module includes a light-emitting diode element, a diode element and a capacitor element. The diode element is selectively disposed between the first terminal of the light-emitting diode element and the first terminal of the light-emitting diode module, or disposed between the second terminal of the light-emitting diode element and the second terminal of the light-emitting diode module. The light-emitting diode element and the capacitor element are connected in parallel.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a circuit view of a conventional switch circuit for light-emitting diode.

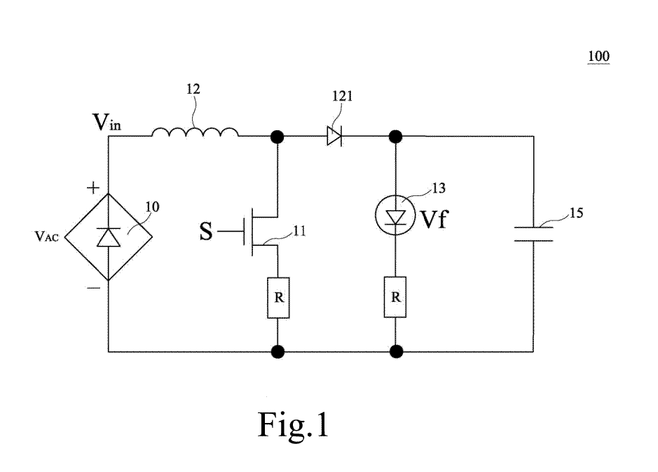

FIG. 2 is a circuit view of an embodiment of a switch circuit for light-emitting diode of the present invention.

FIG. 3 is a circuit view of other embodiment of the switch circuit for light-emitting diode of the present invention.

FIG. 4 is a circuit view of another embodiment of the switch circuit for light-emitting diode of the present invention.

FIG. 5 is a circuit view of another embodiment of a switch circuit for light-emitting diode of the present invention.

FIG. 6 is a circuit view of another embodiment of the switch circuit for light-emitting diode of the present invention.

FIG. 7 is a circuit view of another embodiment of the switch circuit for light-emitting diode of the present invention.

FIG. 8 is a circuit view of another embodiment of the switch circuit for light-emitting diode of the present invention.

FIG. 9 is a circuit view of another embodiment of the switch circuit for light-emitting diode of the present invention.

FIG. 10 is a circuit view of another embodiment of the switch circuit for light-emitting diode of the present invention.

FIG. 11 is a circuit view of another embodiment of the switch circuit for light-emitting diode of the present invention.

FIG. 12 is a circuit view of another embodiment of the switch circuit for light-emitting diode of the present invention.

FIG. 13 is a circuit view of another embodiment of the switch circuit for light-emitting diode of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

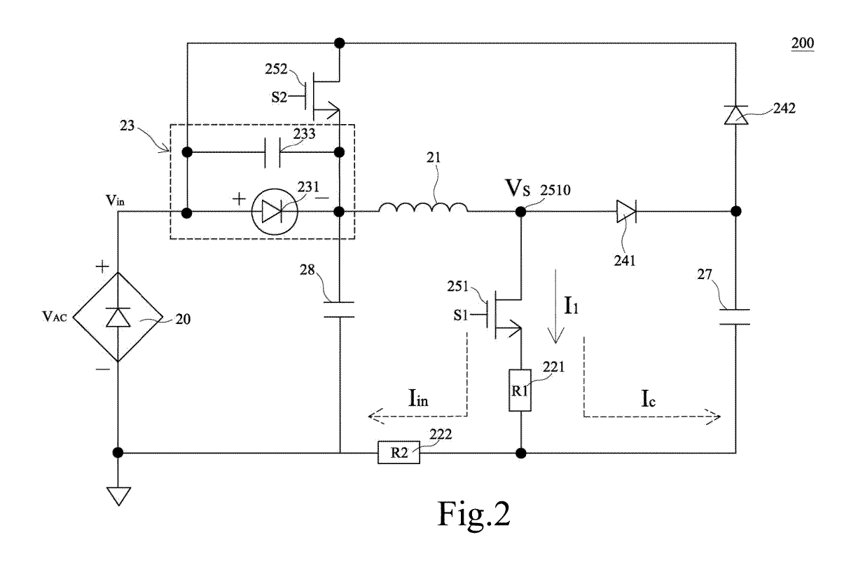

Please refer to FIG. 2 which is a circuit view of an embodiment of a switch circuit for a light-emitting diode of the present invention. As shown in FIG. 2, in this embodiment a switch circuit for light-emitting diode 200 is a boost-buck switch circuit including a power module 20, an inductor 21, a light-emitting diode module 23, a first switch 251, a second switch 252 and a first capacitor 27.

The power module 20 can be a bridge rectifier including a first terminal (such as a positive terminal) and a second terminal (such as a negative terminal), and configured to convert AC power V_{AC} from commercial power into a DC input voltage V_{IN} with pulses. The light-emitting diode module 23 has a first terminal (such as an anode) electrically connected to the first terminal of the power module 20, and a second terminal (such as a cathode) electrically connected to an end of the inductor 21. The first switch 251 has a first end (such as a drain terminal or a collector terminal) electrically connected to other end of the inductor 21, a control end (such as a gate terminal or a base terminal) for receiving a first control signal S1, and a second end (such as a source terminal or an emitter terminal) electrically connected to the second terminal of the power module 20. The first switch 251 is controlled by the first control signal S1 to turn on or turn off. The second switch 252 has a first end (such as a drain terminal or a collector terminal) electrically connected to the first terminal of the light-emitting diode module 23, a control end (such as a gate terminal or a base terminal) for receiving a second control signal S2, and a second end (such as a source terminal or an emitter terminal) electrically connected to the second terminal of the light-emitting diode module 23. The second switch 252 is controlled according to the second control signal S2 to turn on or turn off. The first capacitor 27 has an end electrically connected to other end of the inductor 21 via a first diode 241 and electrically connected to the first terminal of the light-emitting diode module 23 and the first end of the second switch 252 via a second diode 242, and other end electrically connected to the second terminal of the power module 20.

The light-emitting diode module 23 includes a light-emitting diode element 231 having a first terminal and a second terminal. In an embodiment of the present invention, the light-emitting diode element 231 can be consisted of one light-emitting diode or multiple light-emitting diodes. Furthermore, the light-emitting diode module 23 further includes a capacitor element 233 which is electrically connected with the light-emitting diode element 231 in parallel. The capacitor element 233 and the light-emitting diode element 231 can share the current provided from the power module 20 or the first capacitor 27. When the current provided by the inductor becomes lower, the capacitor element 233 discharges a part of stored energy to the light-emitting diode element 231 to drive the light-emitting diode element 231 to work continuously. By means of disposal of the capacitor element 233, the quick fluctuation occurred on the current passing through the light-emitting diode element 231 can be reduced, and the opportunity of highly frequent glitter can be reduced. Moreover, the lighting efficiency and utilization rate of the light-emitting diode element 231 can also be improved.

The switch circuit 200 of this embodiment provides several control manners for the switch. For example, when the input voltage VIN of the power module 20 is higher, the second switch 252 is controlled to turn off and the first switch 251 is quickly switched periodically or according to magnitude of the sensed current I1, and the power module 20 can provide energy to the light-emitting diode module 23, charge the inductor 21 (during turning-on of the first switch) and/or the first capacitor 27 (during turning-off of the first switch 251). The charge-discharge circulation of the inductor 21 is a conventional technology of switching power supply circuit, so its detailed description is omitted.

Alternatively, when the switch circuit 200 is controlled by a system for better performance (for example, when the input voltage V_{IN} of the power module 20 and the storage voltage of the first capacitor 27 both are lower than the forward bias voltage of the light-emitting diode module 23), the first switch 251 is controlled periodically and the second switch 252 is switched quickly, or the first switch 251 and the second switch 252 are quickly switched according to the magnitude of the sensed current I1 (at this time the switching statuses of the first switch 251 and the second switch 252 are substantially synchronous in the same phase). When the first switch 251 and the second switch 252 are turned on, the energy provided by the power module 20 and the first capacitor 27 both are charged into the inductor 21 directly instead of passing through the light-emitting diode module 23. Afterwards, when the inductor 21 is charged to certain energy, the first switch 251 and the second switch 252 are controlled to turn off correspondingly, the first capacitor 27 stops discharging but the inductor 21 starts to discharge energy to the light-emitting diode module 23 for emitting light. Therefore, even if the input voltage V_{IN} of the power module 20 and the storage voltage of the first capacitor 27 both are lower than the forward bias voltage of the light-emitting diode module 23, the energy provided by the power module 20 or the energy discharged from the first capacitor 27 can be provided to the inductor 21 via the second switch 252 for charging the inductor 21.

In the present invention, the second end of the first switch 251 can be electrically connected to the second terminal of the power module 20 via a first resistor (R1) 221 and a second resistor (R2) 222 serially connected with each other, and other end of the first capacitor 27 is electrically connected to the second terminal of the power module 20 via the second resistor 222. In an embodiment of the present invention, an external controller (not shown in Figs) can be used to control the switching action of the switch circuit 200. The controller can be set a fixed reference voltage V_{R}. During actual operation, the controller compares the node voltage V_{S} generated on the first switch 251 with the reference voltage V_{R}, to determine the switching action of the first switch 251. For example, when the voltage V_{S} is greater than the reference voltage VR, the first switch 251 is controlled to turn off; when the voltage V_{S} is lower than the reference voltage V_{R}, the first switch 251 is controlled to turn on. The controller determines the timing of switching the first switch 251 according to the comparison result between the reference voltage V_{R} and the node voltage V_{S}.

When the inductor 21 is charged by the power module 20, the voltage VS is determined at the node 2510:

V_{S}=Iᵢₙ*(R1+R2) (1)

Alternatively, when the inductor 21 is charged by the first capacitor 27, the voltage V_{S} is determined at the node 2510:

V_{S}=I_{C}*(R1) (2)

in accordance with the formulas (1) and (2), the formula (3) can be derived:

Iᵢₙ*(R1+R2)=I_{C}*(R1) (3)

According to the formula (3), the charge current Iᵢₙ is inversely proportional to a value of (R1+R2), the discharge current is inversely proportional to a value of R1, so Iᵢₙ:I_{C}=R1:(R1+R2). By setting the resistance ratio between the first resistor (R1) 221 and the second resistor (R2) 222, the current ratio of the current Iᵢₙ, provided by the power module 20 and the discharge current I_{C} of the first capacitor 27 can be determined.

Furthermore, the switch circuit 200 can be further provided with a second capacitor 28. The second capacitor 28 is arranged between the second terminal of the light-emitting diode module 23 and the second terminal of the power module 20. In the switch circuit 200, the second capacitor 28 and the dynamic resistance of the light-emitting diode module 23 are used to form RC low-pass filter effect, so as to suppress the high-frequency interfere occurred at the terminals of the power module 20 while the working current are quickly switched.

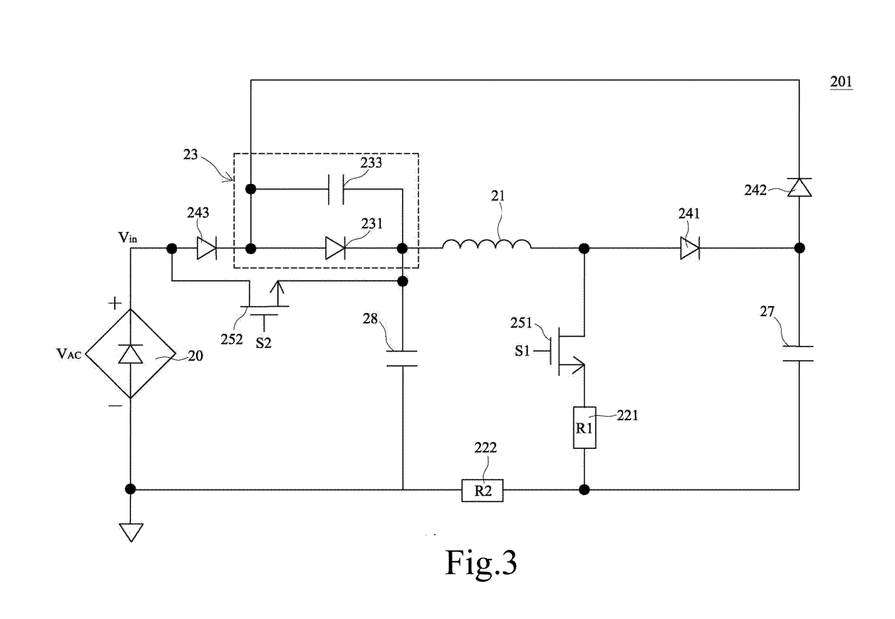

Please refer to FIG. 3 which shows a circuit view of another embodiment of the switch circuit for light-emitting diode of the present invention. As shown in FIG. 3, the switch circuit for light-emitting diode 201 of this embodiment further includes a third diode 243. The first end of the second switch 252 is electrically connected to the first terminal of the light-emitting diode module 23 via the third diode 243. When the input voltage VIN of the power module 20 is high sufficiently, the first switch 251 is turned off and the second switch 252 is controlled to quickly switch. When the input voltage VIN of the power module 20 is lower than the forward bias voltage of the light-emitting diode module 23, the first switch 251 is turned on or the first switch 251 and second switch 252 are controlled to quick switch synchronously in the same phase.

By the circuit design, the inductor 21 can be still charged by the power module 20 via the second switch 252 even if the power module 20 is in a lower-voltage status.

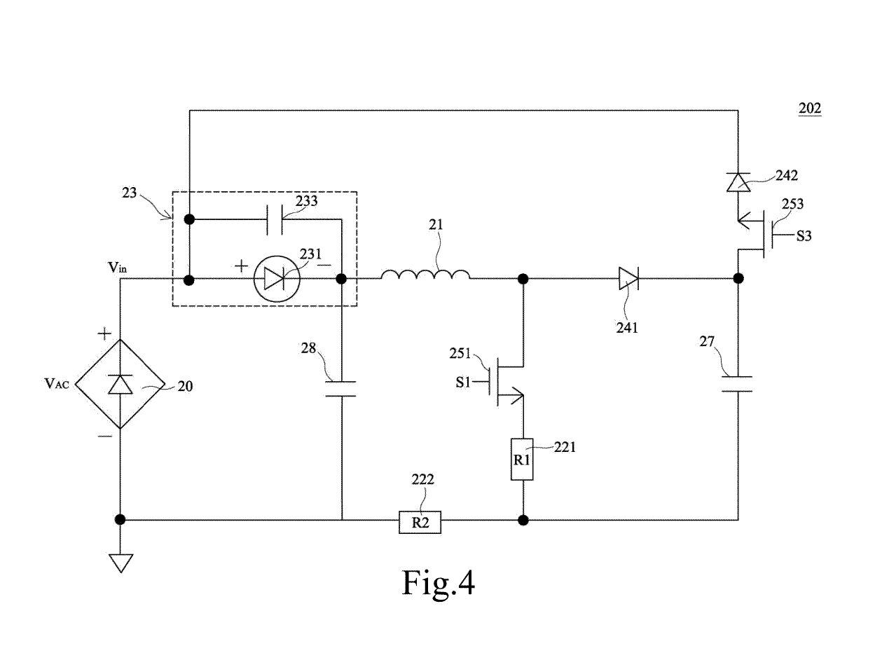

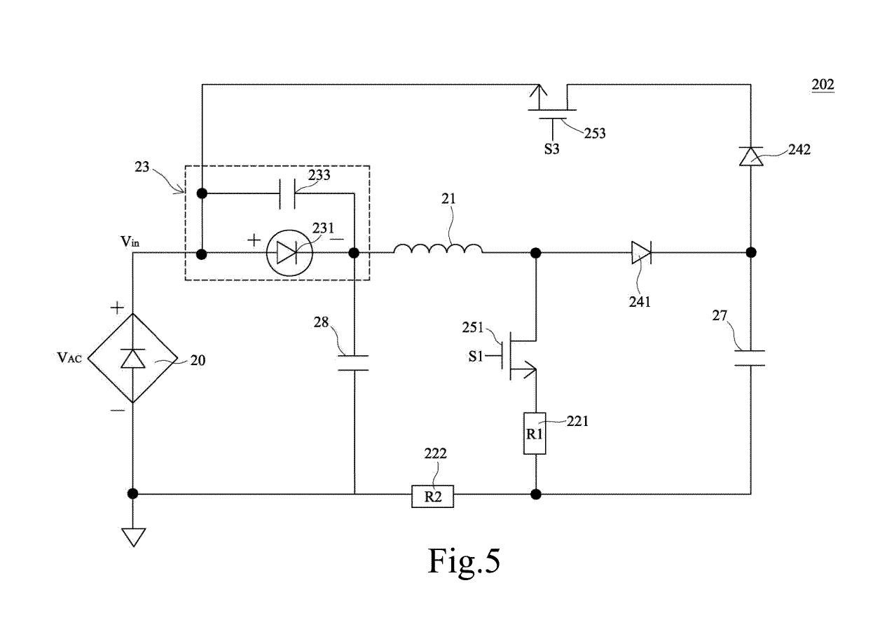

Please refer to FIG. 4 which shows a circuit view of another embodiment of the switch circuit for light-emitting diode of the present invention. Compared with the embodiment shown in FIG. 2, the switch circuit for light-emitting diode 202 of this embodiment is further provided with a third switch 253 instead of the second switch 252. The third switch 253 has a first end (such as a drain terminal or a collector terminal) electrically connected to the end of the first capacitor 27, a control end (such as a gate terminal or a base terminal) configured to receive a third control signal S3, and a second end (such as a source terminal or an emitter terminal) electrically connected to the first terminal of the light-emitting diode module 23 via the second diode 242. Alternatively, as shown in FIG. 5, the third switch 253 can be disposed between the second diode 242 and the first terminal of the light-emitting diode module 23. The first end of the third switch 253 is electrically connected to the end of the first capacitor 27 via the second diode 242, and the second end of the third switch 253 is directly connected to the first terminal of the light-emitting diode module 23. The third switch 253 can be controlled to turn on, turn off or limit current according to the third control signal S3.

When the storage voltage of the first capacitor 27 is higher than the input voltage VIN of the power module 20, the first capacitor 27 charges the light-emitting diode module 23, to replace the power module 20. By means of disposal of the third switch 253, the discharge timing of the first capacitor 27 can be delayed, so as to improve the flexibility of the system in control. For example, when the input voltage V_{IN} of the power module 20 is too low to drive the light-emitting diode module 23, the third switch 253 can be controlled to turn on and the first capacitor 27 discharges energy to the light-emitting diode module 23. By such circuit design, the first capacitor 27 with lower capacitance can be selected to implement the switch circuit of the present invention, so that the volume and cost of the circuit of the present invention can be reduced, and the power factor of the circuit system can be improved and high-frequency glitter of the light-emitting diode module 23 can be solved effectively.

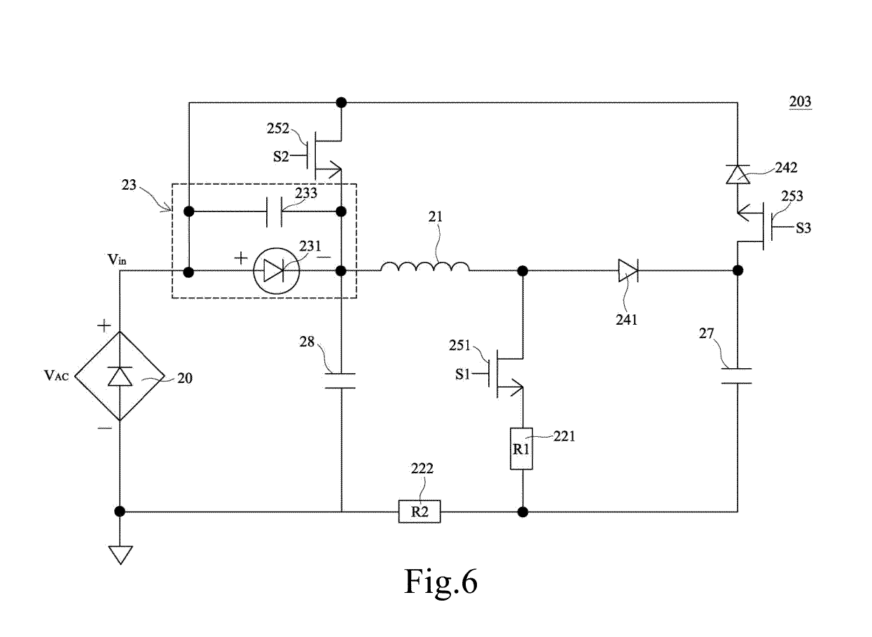

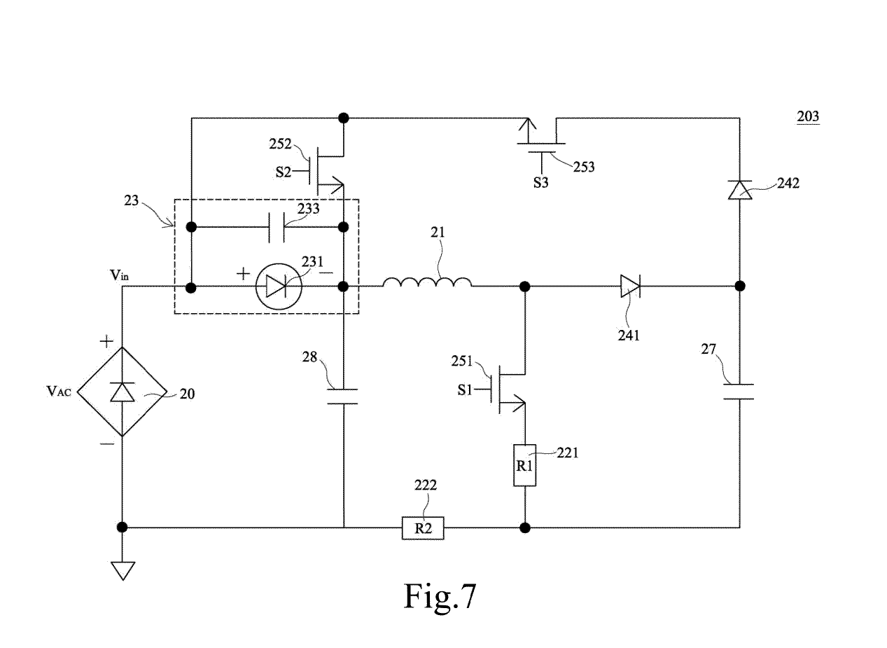

Please refer to FIG. 6 which shows another embodiment of the switch circuit for light-emitting diode of the present invention. In this embodiment, the switch circuit for light-emitting diode 203 integrates with the second switch 252 shown in FIG. 2 and the third switch 253 shown in FIG. 4. Please refer to FIG. 7 which shows another embodiment of the present invention. In this embodiment, the switch circuit for light-emitting diode 203 can integrate with the second switch 252 shown in FIG. 2 and the third switch 253 shown in FIG. 5.

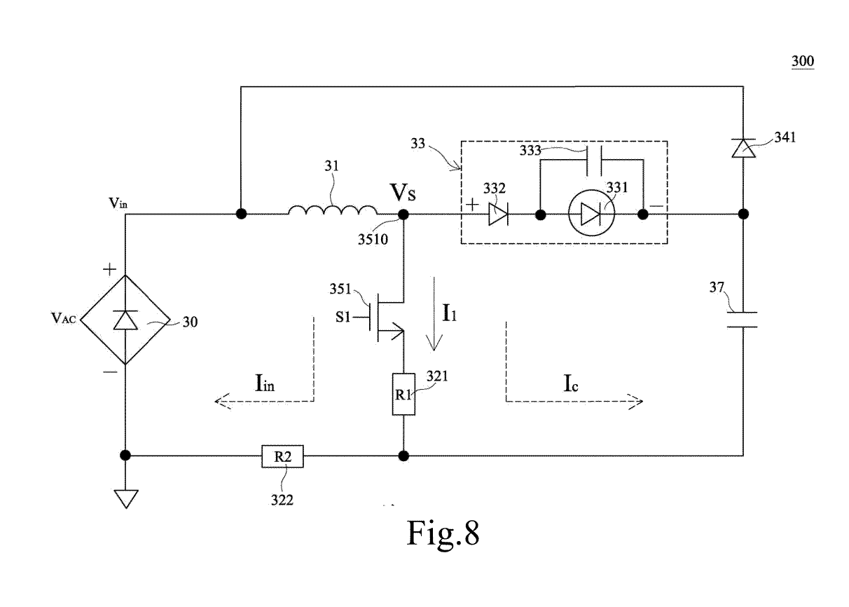

Please refer to FIG. 8 which shows a circuit view of another embodiment of the switch circuit for light-emitting diode of the present invention. As shown in FIG. 8, the switch circuit for light-emitting diode 300 of this embodiment includes a power module 30, an inductor 31, a light-emitting diode module 33, a first switch 351 and a first capacitor 37.

The power module 30 and the light-emitting diode module 33 both have first terminals (such as positive terminals) and second terminals (such as negative terminals). The power module 30 is a bridge rectifier configured to convert the commercial AC power V_{AC} into the DC input voltage V_{IN} with pulses. The inductor 31 has an end electrically connected to the first terminal of the power module 30 and electrically connected to the second terminal of the light-emitting diode module 33 via a first diode 341, and other end electrically connected to the first terminal of the light-emitting diode module 33. The first switch 351 has a first end (such as a drain terminal or a collector terminal) electrically connected to other end of the inductor 31, control end (such as a gate terminal or a base terminal) configured to receive a first control signal S1, and a second end (such as a source terminal or an emitter terminal) electrically connected to the second terminal of the power module 30. The first capacitor 37 has an end electrically connected to the second terminal of the light-emitting diode module 33 and electrically connected to an end of the inductor 31 via a first diode 341, and other end electrically connected to the second terminal of the power module 30. The first switch 352 can be controlled by the first control signal S1 to turn on or turn off.

The light-emitting diode module 33 includes a diode element 332, a capacitor element 333, a light-emitting diode element 331 having a first terminal and a second terminal. The diode element 332 can be selectively arranged between the first terminal of the light-emitting diode element 331 and the first terminal of the light-emitting diode module 33, or between the second terminal of the light-emitting diode element 331 and the second terminal of the light-emitting diode module 33. The capacitor element 333 and the light-emitting diode element 331 are connected in parallel, so as to reduce high-frequency glitter of the light-emitting diode element 331 and improve the lighting efficiency and utilization rate of the light-emitting diode element 331.

According to a switch control manner for the switch circuit for light-emitting diode 300 of this embodiment, the first control signal S1 is used to control the first switch 351 to quickly switch periodically or according to the magnitude of the sensed current I1, and at this time the energy provided by the power module 30 or the first capacitor 37 can charge the inductor 31, for example when the first switch 351 is turned on; or the inductor 31 discharges energy to the light-emitting diode module 33, for example, when the first switch 351 is turned off.

Similar to the embodiment shown in FIG. 2, the second end of the first switch 351 of this embodiment can be electrically connected to the second terminal of the power module 30 via a first resistor (R1) 321 and a second resistor (R2) 322 which are serially connected. Other end of the first capacitor 37 is electrically connected to the second terminal of the power module 30 via the second resistor 322. The exterior controller can compare the set reference voltage V_{R} and the voltage VS on the node 3510 of the first switch 351, to determine the switching action of the first switch 351, and further obtain the voltage V_{S} according to the formula (1): V_{S}=Iᵢₙ*(R1+R2) or formula (2): V_{S}=I_{C}*(R1). According to formula (1) and (2), the formula Iᵢₙ*(R1+R2)=I_{C}*(R1) can be derived, and Iᵢₙ:I_{C}=R1:(R1+R2) can be obtained.

Therefore, the resistance ratio between the first resistor (R1) 321 and the second resistor (R2) 322 can be set to determine the ratio of the current Iᵢₙ provided by the power module 30 and the discharge current I_{C} of the first capacitor 37.

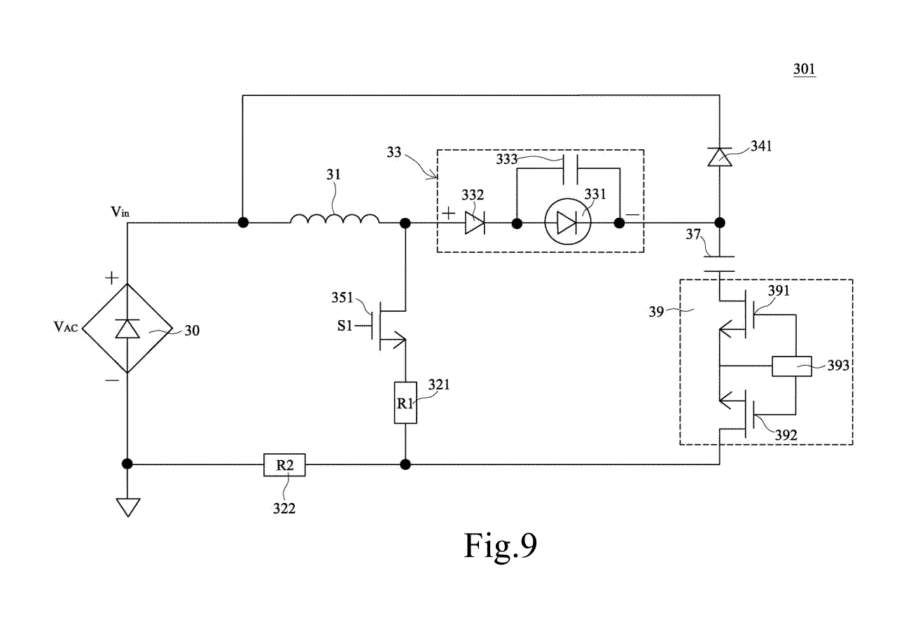

Please refer to FIG. 9 which shows a circuit view of another embodiment of the switch circuit for light-emitting diode of the present invention. Compared to the embodiment shown in FIG. 8, the switch circuit for light-emitting diode 301 of this embodiment further includes a capacitor charge-discharge control module 39 disposed between other end of the first capacitor 37 and the second terminal of the power module 30. The capacitor charge-discharge control module 39 includes a first switch element 391 a second switch element 392 and a control element 393. The first switch element 391 and the second switch element 392 are in back-to-back connection. The first end of the first switch element 391 is electrically connected to other end of the first capacitor 37, the first end of the second switch element 392 is electrically connected to the second terminal of the power module 20, the second end of the first switch element 391 and the second end of the second switch element 392 both are electrically connected to the control element 393, and control ends of the first switch element 391 and the second switch element 392 are respectively connected to the control element 393.

The control element 393 is configured to control the first switch element 391 and the second switch element 392 to turn on or off. When the control element 393 controls the second switch element 392 to turn off, discharging of the first capacitor 37 is stopped. When the control element 393 controls the first switch element 391 to turn off, charging of the first capacitor 37 is stopped. By means of the controlling of the capacitor charge-discharge control module 39 in charge-discharge of the first capacitor 37, the first capacitor 37 with lower capacitance can be selected to use in the switch circuit for light-emitting diode 300. Furthermore, the switch elements 391 and 392 of this embodiment are NMOS switches for illustration, the MOS switches all have characteristic of body diode and turning-off operation of the MOS switch is directional, so in this embodiment the switch elements 391 and 392 are designed as a structure of back-to-back connection. Alternatively, the capacitor charge-discharge control module 39 can be provided with an ideal switch to replace the NMOS switches.

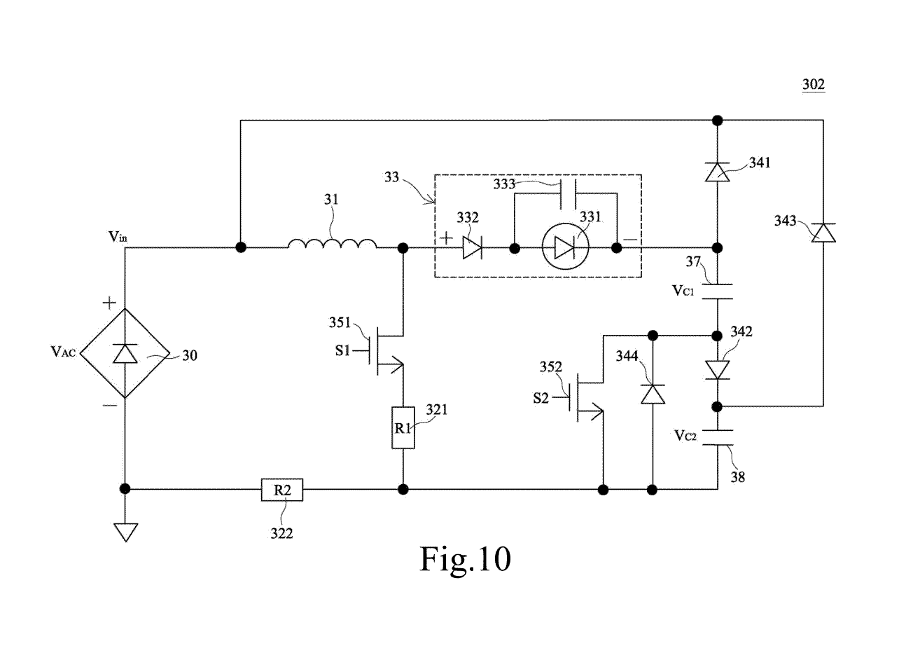

Please refer to FIG. 10 which is a circuit view of another embodiment of the switch circuit for light-emitting diode of the present invention. Compared with the embodiment shown in FIG. 8, the switch circuit for light-emitting diode 302 of this embodiment further includes a second switch 352 and a second capacitor 38.

An end of the second capacitor 38 is electrically connected to other end of the first capacitor 37 via a second diode 342 and electrically connected to an end of the inductor 31 via a third diode 343, and other end of the second capacitor 38 is electrically connected to the second terminal of the power module 30. A fourth diode 344 is connected in parallel with the other end of the first capacitor 37 and other end of the second capacitor 38; alternatively, the second switch 352 can be in body-diode connection to form characteristic of a diode.

The second switch 352 has a first end electrically connected to other end of the first capacitor 37, a control terminal configured to receive a second control signal S2, and a second end electrically connected to the second terminal of the power module 30. According to the second control signal S2, the second switch 352 is controlled to turn on or turn off.

When the sum of voltages of the first capacitor 37 and the second capacitor 38 reach the level of the input voltage V_{IN} of the power module 30, the power module 30 fails to continue charging the first capacitor 37 and the second capacitor 38, and at this time, when the second switch 352 is controlled to turn on, the power module 30 can continue charging the first capacitor 37 via a current path between the first capacitor 37 and the second switch 352, to enable the voltage (V_{C1}) of the first capacitor 37 to reach the level of the input voltage V_{IN}. By such circuit design, the charging time of the first capacitor 37 can be extended and the power factor of the circuit system can be improved, and the charge quantity of the first capacitor 37 can be increased to raise the sum of storage voltages of the first capacitor 37 and the second capacitor 38.

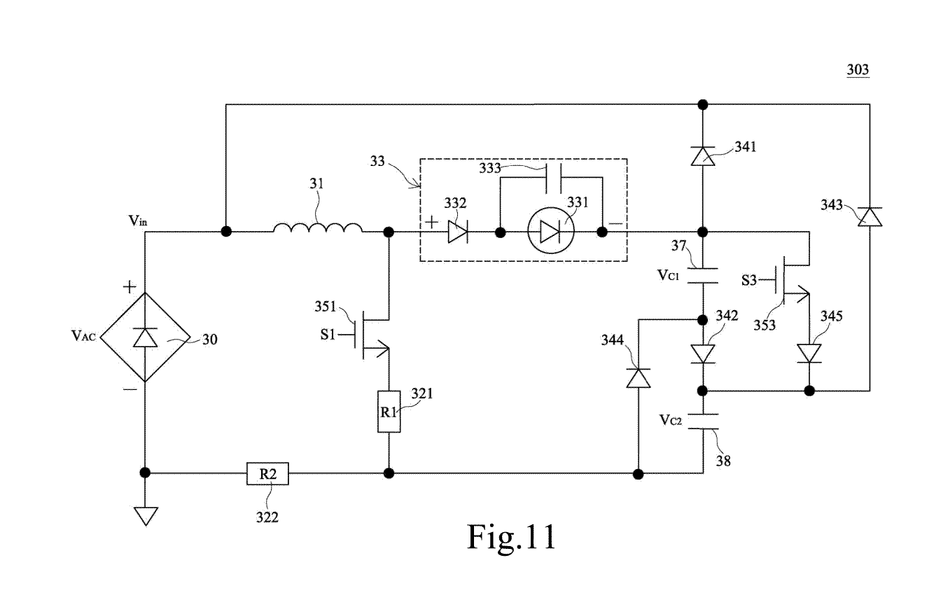

Please refer to FIG. 11 which shows a circuit view of another embodiment of the switch circuit for light-emitting diode of present invention. Compared with the embodiment shown in FIG. 8. The switch circuit for light-emitting diode 303 of this embodiment further includes a third switch 353 and a second capacitor 38.

An end of the second capacitor 38 is electrically connected to other end of the first capacitor 37 via a second diode 342 and electrically connected to an end of the inductor 31 via a third diode 343. Other end of the second capacitor 38 is electrically connected to the second terminal of the power module 30. A fourth diode 344 is electrically connected in parallel with the other end of the first capacitor 37 and the other end of the second capacitor 38. The third switch 353 has a first end electrically connected to the end of the first capacitor 37, a control end configured to receive a third control signal S3, and a second end electrically connected to an end of the second capacitor 38 via a fifth diode 345. According to the third control signal S3, the third switch 353 can be controlled to turn on or turn off.

When a sum (V_{C1}+V_{C2}) of the storage voltages of the first capacitor 37 and the second capacitor 38 reaches the level of the input voltage V_{IN} of the power module 30, the power module 30 fails to continue charging the first capacitor 37 and the second capacitor 38, and at this time if the third switch 353 is controlled to turn on, the power module 30 can continue charging the second capacitor 38 via a current path between the third switch 353, the fifth diode 345 and the second capacitor 38, to enable the storage voltage (V_{C2}) of the second capacitor 38 to reach the level of the input voltage V_{IN}. By such circuit design, the charging time of the second capacitor 38 can be extended and the power factor of the circuit system can be improved, and the charge quantity of the second capacitor 38 can be further increased and the sum of the storage voltage of the first capacitor 37 and the second capacitor 38 can be raised.

In further embodiment of the present invention, the second switch 352 shown in FIG. 10 can be disposed in the switch circuit for light-emitting diode 303. By means of the switching operations of the second switch 352 and the third switch 353, the charging times of the first capacitor 37 and the second capacitor 38 can be respectively extended and the sum of the storage voltage of the first capacitor 37 and the second capacitor 38 can be further raised.

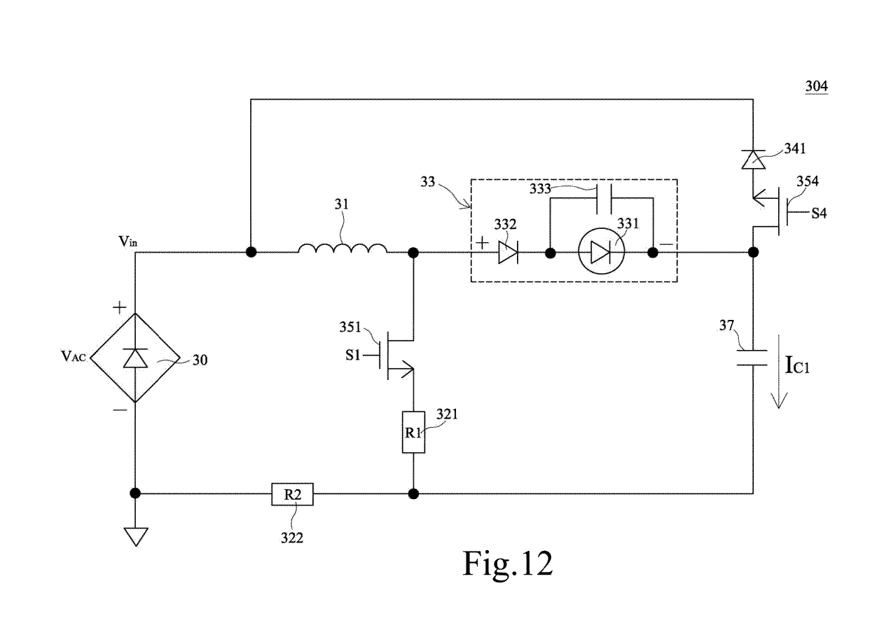

Please refer to FIG. 12 which shows a circuit view of another embodiment of the switch circuit for light-emitting diode of the present invention. Compared with the embodiment shown in FIG. 8, the switch circuit for light-emitting diode 304 of this embodiment further includes a fourth switch 354.

The fourth switch 354 is disposed between the first diode 341 and the first capacitor 37, and has a first end electrically connected to the end of the first capacitor 37, a control end configured to receive a fourth control signal S4, and a second end electrically connected to the end of the inductor 31 via the first diode 341. According to the fourth control signal S4, the fourth switch 354 is controlled to turn on, off, or limit current.

By means of disposal of the fourth switch 354, the discharging time of the first capacitor 37 can be delayed, so as to increase flexibility of the system in control. When the power module 30 fails to provide sufficient energy to the inductor 31 and/or the light-emitting diode module 33, the fourth switch 354 is controlled to turn on to enable the first capacitor 37 to discharge, so as to charge the inductor 31 when the first switch 35 is turned on; or drive the light-emitting diode module 33 to emit light when the first switch 351 is turned off. By such circuit design, the first capacitor 37 with a lower capacitance can be selected to use in the switch circuit of the present invention, to reduce volume and cost of the circuit and further effectively improve the power factor of the circuit system and the solve the high-frequency glitter problem of the light-emitting diode module 33.

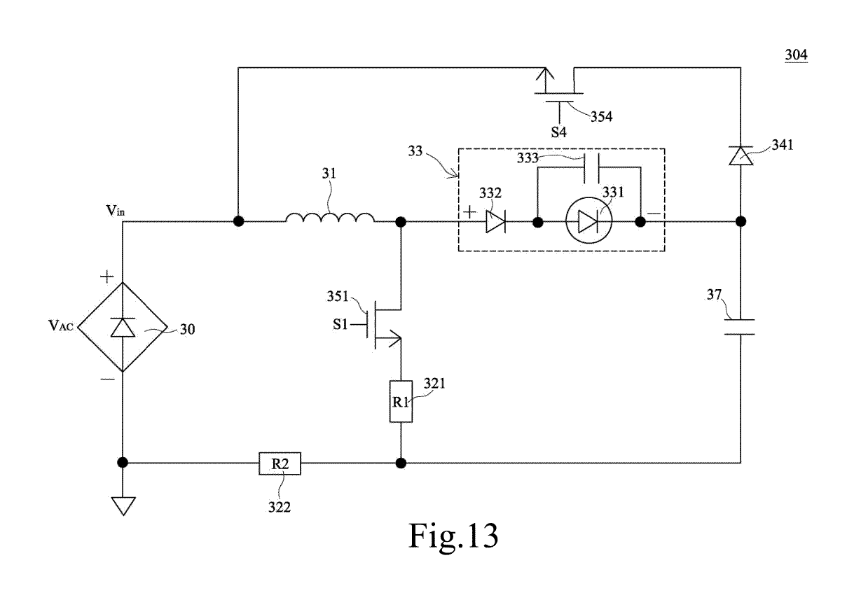

Please refer to FIG. 13 which shows another embodiment of the present invention. In this embodiment, the fourth switch 354 is disposed between the first diode 341 and an end of the inductor 31. The fourth switch 354 has a first end electrically connected to an end of the first capacitor 37 via the first diode 341, a control end configured to receive a fourth control signal S4, and a second end electrically connected to an end of the inductor 31. Naturally, in other embodiment of the present invention, the fourth switch 354 can also disposed in the switch circuit for light-emitting diode 302 of FIG. 10 or the switch circuit for light-emitting diode 303 of FIG. 11, to delay the discharging of the first capacitor 37 and the second capacitor 38 to improve the power factor of the circuit system and solve the high-frequency glitter problem of the light-emitting diode module 33.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A switch circuit for light-emitting diode, comprising:
a power module, having a first terminal and a second terminal;
a light-emitting diode module, having a first terminal and a second terminal, and the first terminal of the light-emitting diode module connected to the first terminal of the power module;
an inductor, having an end connected to the second terminal of the light-emitting diode module;
a first switch, having a first end connected to other end of the inductor, a control end configured to receive a first control signal, and a second end connected to the second terminal of the power module, wherein the first switch is controlled to turn on or off according to the first control signal;
a second switch, having a first end connected to the first terminal of the light-emitting diode module, a control end configured to receive a second control signal control signal and a second end connected to the second terminal of the light-emitting diode module, wherein the second switch is controlled to turn on or off according to the second control signal; and
a first capacitor, having an end connected to the other end of the inductor via a first diode and connected to the first terminal of the light-emitting diode module and the first end of the second switch via a second diode, and other end connected to the second terminal of the power module.

2. The switch circuit for light-emitting diode according to claim 1, wherein the second end of the first switch is connected to the second terminal of the power module via a first resistor and a second resistor which are serially connected, the other end of the first capacitor is connected to the second terminal of the power module via the second resistor, and the resistance ratio of the first resistor and the second resistor is set to determine a ratio of current provided by the power module and discharge current of the first capacitor.

3. The switch circuit for light-emitting diode according to claim 1, wherein the light-emitting diode module comprises a light-emitting diode element and a capacitor element, and the light-emitting diode element and the capacitor element are connected in parallel.

4. The switch circuit for light-emitting diode according to claim 1, further comprising a second capacitor disposed between the second terminal of the light-emitting diode module and the second terminal of the power module.

5. The switch circuit for light-emitting diode according to claim 1, further comprising a third switch having a first end connected to the end of the first capacitor, a control end configured to receive a third control signal, and a second end connected to the first terminal of the light-emitting diode module and the first end of the second switch via the second diode, wherein the third switch is controlled to turn on, turn off or limit current according to the third control signal.

6. The switch circuit for light-emitting diode according to claim 1, further comprising a third switch having a first end connected to the end of the first capacitor via the second diode, a control end configured to receive a third control signal, and a second end connected to the first terminal of the light-emitting diode module and the first end of the second switch, wherein the third switch is controlled to turn on, turn off, or limit current according to the third control signal.

7. The switch circuit for light-emitting diode according to claim 1, wherein the first end of the second switch is connected to the first terminal of the light-emitting diode module via the third diode.

8. The switch circuit for light-emitting diode according to claim 7, wherein the second switch is controlled to turn on, so as to enable the power module to charge the inductor.

9. A switch circuit for light-emitting diode, comprising:
a power module, having a first terminal and a second terminal;
a light-emitting diode module, having a first terminal and a second terminal, and the first terminal of the light-emitting diode module connected to the first terminal of the power module;
an inductor, having an end connected to the second terminal of the light-emitting diode module;
a first switch, having a first end connected to other end of the inductor, a control end configured to receive a first control signal, and a second end connected to the second terminal of the power module, wherein the first switch is controlled to turn on or turn off according to the first control signal;
a first capacitor, having an end connected to other end of the inductor via a first diode and connected to the first terminal of the light-emitting diode module via a second diode, and other end connected to the second terminal of the power module; and
a second capacitor, disposed between the second terminal of the light-emitting diode module and the second terminal of the power module.

10. The switch circuit for light-emitting diode according to claim 9, wherein the second end of the first switch is connected to the second terminal of the power module via a first resistor and a second resistor which are serially connected, and the other end of the first capacitor is connected to the second terminal of the power module via the second resistor, wherein the resistance ratio of the first resistor and the second resistor is set to determine a ratio of current provided by the power module and the discharge current of the first capacitor.

11. The switch circuit for light-emitting diode according to claim 9, further comprising a third switch having a first end connected to the end of the first capacitor, a control end configured to receive a third control signal, and a second end connected to the first terminal of the light-emitting diode module via the second diode, wherein the third switch is controlled to turn on, turn off or limit current according to the third control signal.

12. The switch circuit for light-emitting diode according to claim 9, further comprising a third switch having a first end connected to the end of the first capacitor via the second diode, a control end configured to receive a third control signal, and a second end connected to the first terminal of the light-emitting diode module;
wherein the third switch is controlled to turn on, turn off or limit current according to the third control signal.

13. The switch circuit for light-emitting diode according to claim 9, wherein the light-emitting diode module comprises a light-emitting diode element and a capacitor element, and the light-emitting diode element and the capacitor element are connected in parallel.

14. A switch circuit for light-emitting diode, comprising:
a power module, having a first terminal and a second terminal;
a light-emitting diode module, having a first terminal and a second terminal;
an inductor, having an end connected to the first terminal of the power module and connected to the second terminal of the light-emitting diode module via a first diode, and having other end connected to the first terminal of the light-emitting diode module;
a first switch, having a first end connected to the other end of the inductor, a control end configured to receive a first control signal, and a second end connected to the second terminal of the power module, wherein the first switch is controlled to turn on or turn off according to the first control signal; and
a first capacitor, having an end connected to the second terminal of the light-emitting diode module, and other end connected to the second terminal of the power module.

15. The switch circuit for light-emitting diode according to claim 14, wherein the second end of the first switch is connected to the second terminal of the power module via a first resistor and a second resistor which are serially connected, the other end of the first capacitor is connected to the second terminal of the power module via the second resistor, and a resistance value of the first resistor and the second resistor is set to determine a ratio of current provided by the power module and discharge current of the first capacitor.

16. The switch circuit for light-emitting diode according to claim 14, further comprising a capacitor charge-discharge control module, disposed between the other end of the first capacitor and the second terminal of the power module, wherein the capacitor charge-discharge control module comprises a first switch element, a second switch element and a control element, a first end of the first switch element is connected to the other end of the first capacitor, a first end of the second switch element is connected to the second terminal of the power module, a second end of the first switch element and a second end of the second switch element both are connected to the control element, control ends of the first switch element and the second switch element are respectively connected to the control element;
wherein the first capacitor is stopped being discharged when the second switch element is controlled by the control element to turn off;
wherein the first capacitor is stopped being charged when the first switch element is controlled by the control element to turn off.

17. The switch circuit for light-emitting diode according to claim 14, further comprising a second switch and a second capacitor, wherein the second capacitor has an end connected to the other end of the first capacitor via a second diode and connected to the end of the inductor via a third diode, and having other end connected to the second terminal of the power module, and a fourth diode is connected between the other end of the first capacitor and the other end of the second capacitor in parallel;
wherein the second switch has a first end connected to the other end of the first capacitor, a control end configured to receive a second control signal, and a second end connected to the second terminal of the power module;
wherein the power module charges the first capacitor and the second capacitor when the first switch and the second switch are controlled to turn off, and the power module charges the first capacitor when the first switch is controlled to turn off and the second switch is controlled to turn on.

18. The switch circuit for light-emitting diode according to claim 14, further comprising a third switch and a second capacitor, wherein the second capacitor has an end connected to the other end of the first capacitor via a second diode and connected to the end of the inductor via a third diode, and has other end connected to the second terminal of the power module; wherein a fourth diode is connected between the other end of the first capacitor and the other end of the second capacitor in parallel; the third switch has a first end connected to the end of the first capacitor, a control end configured to receive a third control signal, and a second end connected to an end of the second capacitor via a fifth diode;
wherein the power module charges the first capacitor and the second capacitor when the first switch and the third switch are controlled to turn off, and the power module charges the second capacitor when the first switch is controlled to turn off and the third switch is controlled to turn on.

19. The switch circuit for light-emitting diode according to claim 14, further comprising a fourth switch having a first end connected to the end of the first capacitor, a control end configured to receive a fourth control signal, and a second end connected to the end of the inductor via the first diode, wherein the fourth switch is controlled to turn on, turn off, or limit current according to the control signal.

20. The switch circuit for light-emitting diode according to claim 14, further comprising a fourth switch having a first end connected to the end of the first capacitor via the first diode, a control end configured to receive a fourth control signal, and a second end connected to the end of the inductor, wherein the fourth switch is controlled to turn on, turn off or limit current according to the fourth control signal.

21. The switch circuit for light-emitting diode according to claim 14, wherein the light-emitting diode module comprises a light-emitting diode element, a diode element and a capacitor element, the diode element is selectively disposed between the first terminal of the light-emitting diode element and the first terminal of the light-emitting diode module, or disposed between the second terminal of the light-emitting diode element and the second terminal of the light-emitting diode module, and the light-emitting diode element and the capacitor element are connected in parallel.
